(19) United States
(12) Patent Application Publication
(10) Pub. No.: US 2024/0420093 A1
(43) Pub. Date: Dec. 19, 2024

(54) CONTEXTUAL DATA AUGMENTATION FOR SOFTWARE ISSUE PRIORITIZATION

(71) Applicant: SAP SE, Walldorf (DE)

(72) Inventors: Masoud Aghadavoodi Jolfaei, Wiesloch (DE); Frank Brunswig, Heidelberg (DE)

(21) Appl. No.: 18/211,452

(22) Filed: Jun. 19, 2023

(51) Int. Cl. G06Q 10/20; G06Q 10/0637

(52) U.S. Cl. CPC G06Q 10/20; G06Q 10/06375

(57) ABSTRACT

Systems and methods described herein relate to techniques for identifying and using context data to prioritize reported issues in a software context. A data record of a reported issue is accessed. The reported issue is associated with a software offering provided to a user. The data record comprises issue metadata that includes a first priority rating for the reported issue. The issue metadata is used to identify a relation between the reported issue and context data associated with the user. A second priority rating for the reported issue is generated based on at least the context data. The second priority rating may differ from the first priority rating. The second priority rating is presented at a computing device, optionally together with the first priority rating via a graphical user interface.

### TECHNICAL FIELD

The subject matter disclosed herein generally relates to the tracking or processing of software-related issues. More specifically, but not exclusively, the subject matter relates to the identification and use of context data to facilitate prioritization of such issues.

### BACKGROUND

In the context of software-related products and services, referred to in this disclosure as “software offerings,” it is common for issues to emerge that require intervention. Examples of these issues include bugs, defects, availability or connectivity issues, testing or deployment problems, enhancement requests, development requests, threats, or risks. Issues can originate internally, e.g., an issue can be detected by an internal development team of a software offering provider, or externally, e.g., an incident can be reported by a user. In some cases, issues are generated automatically, e.g., system-generated crash feedback.

An issue can be brought to the attention of an appropriate entity or team by submitting a report, often referred to as a “ticket” or a “case.” The report may include a priority rating that is intended to indicate the urgency or importance of the issue. While a priority rating can be used to manage workload and allocate resources, e.g., to assign resources to what appears to be the most urgent issues first, the priority rating may be based on limited or subjective information, thus leading to suboptimal prioritization. For example, a priority rating may be assigned to an issue that a user is experiencing with a software offering based solely on a description of the issue itself, without considering other factors, such as the potential impact of the issue on other software offerings used by the user.

### BRIEF DESCRIPTION OF THE DRAWINGS

Some examples are shown for purposes of illustration and not limitation in the figures of the accompanying drawings. In the drawings, which are not necessarily drawn to scale, like numerals may describe similar components in different views or examples. To identify the discussion of any particular element or act more easily, the most significant digit or digits in a reference number refer to the figure number in which that element is first introduced.

FIG. 1 is a diagrammatic representation of a network environment that includes an issue tracking system, according to some examples.

FIG. 2 is a block diagram of certain components of an issue tracking system, according to some examples.

FIG. 3 is a flowchart illustrating operations of a method suitable for identifying and using context data to generate a priority rating for a reported issue, according to some examples.

FIG. 4 is a user interface diagram illustrating a graphical user interface (GUI) of an issue tracking system, according to some examples, in which an issue dashboard is shown.

FIG. 5 is a block diagram in the form of a relationship diagram, illustrating relations between multiple reported issues, as well as context data, according to some examples.

FIG. 6 is a block diagram in the form of an interaction diagram, illustrating the manner in which a context detection component interacts with multiple context attributes, according to some examples.

FIG. 7 is a user interface diagram illustrating a GUI of an issue tracking system, according to some examples, in which details of a reported issue are shown.

FIG. 8 is a user interface diagram illustrating a GUI of an issue tracking system, according to some examples, in which user contract details are shown.

FIG. 9 diagrammatically illustrates training and use of a machine learning program, according to some examples.

FIG. 10 is a block diagram showing a software architecture for a computing device, according to some examples.

FIG. 11 is a block diagram of a machine in the form of a computer system, according to some examples, within which instructions may be executed for causing the machine to perform any one or more of the methodologies discussed herein.

### DETAILED DESCRIPTION

Systems and methods described herein relate to techniques for identifying and using context data to prioritize reported issues. As used in this disclosure, the term “issue” refers to any incident, problem, query, or request that may arise in the context of a software offering. The term “reported issue” refers to an issue that has been reported, submitted, or logged, e.g., in an issue tracking system or issue handling system. Further, as used in this disclosure, the term “priority rating” refers to any rating, ranking, score, grading, classification, or other determinable measure or indicator, intended to indicate or establish the urgency or severity of an issue, the importance of addressing the issue, or combinations thereof.

As mentioned, in some cases, a priority rating may be assigned to an issue based on limited or subjective information. For example, the priority rating may be established based on the apparent urgency of the issue when the issue is considered in isolation (e.g., considering only a description of the issue as submitted by a user). As a result, the priority rating may fail to account adequately for other relevant factors, attributes, or items that could influence the urgency, importance, or severity of the issue, or the consequences of failing to address the issue. Such other factors, attributes, or items are referred to in this disclosure as “context,” and the term “context data” is used to refer to any data relating to such relevant factors, attributes, or items.

For example, a reported issue relating to a first service offering of a service offering provider may have an assigned priority rating of “low,” based solely on a description of the reported issue as provided by a user (or, as another example, automatically generated by a system based on a predefined severity associated with the issue). Based on this assigned priority rating, the reported issue is positioned in an issue queue and resources are allocated such that the reported issue can be addressed within approximately one week. However, context associated with the reported issue indicates that the user in question has a service level agreement in place that specifies a minimum timeframe for resolving issues of three days. The context may indicate that failure to address the issue within three days will heighten the risk of the user not renewing the service level agreement. Further, the context indicates that failure to address the issue within two days will endanger the operation of a second, interconnected service offering provided to the user. Based on this context, it may be both technically and commercially beneficial for the reported issue to be assigned a higher priority rating, e.g., “high” or “urgent.”

Examples described herein provide for the identification and use of context data to generate a priority rating. According to some examples, a method includes accessing a data record of a reported issue. The reported issue is associated with a software offering provided to a user. The user may, for example, be a customer or client of a software offering provider. The data record comprises issue metadata. The issue metadata may include identifying information, such as a user identifier, a reported issue identifier, a reported issue description, a software offering identifier, or a software offering instance identifier.

In some cases, the issue metadata includes a first priority rating for the reported issue. The first priority rating may be an initial priority rating assigned to the reported issue, e.g., without analyzing context, as further described below.

The issue metadata is used to identify a relation between the reported issue and context data associated with the user. For example, identifying information in the data record of the reported issue may be used to retrieve context data from one or more available repositories, e.g., a sales opportunity pipeline, a contract data database, a repository of other reported issues relating to the user, or software package provisioning data. The method may include retrieving context data from runtime environments of service or product instances.

A contextual dependency between the reported issue and context data may be detected. For example, a system as described herein may detect that a first software offering instance, which is the subject of the reported issue, is interconnected with a second software offering instance of the same user, and that non-operation of the first software offering instance may cause an incident with respect to the second software offering instance.

In some examples, data corresponding to one or more context attributes are identified and retrieved to augment the data record. Thus, the issue metadata of the data record may be augmented with context data, or augmented with additional context data, to obtain augmented issue metadata.

The method may include generating a second priority rating based on the context data, e.g., based on the augmented issue metadata. The second priority rating may be referred to as a “context-aware” priority rating. Generating the second priority rating may include determining, based on the context data, the data record, the augmented issue metadata, or combinations thereof, an estimated impact associated with the reported issue. The estimated impact may be an estimated business impact, e.g., an estimated business impact of failure to address the reported issue (or failure to address the reported issue within a certain timeframe) on a business of the user, on a business of the software offering provider, or both.

As used in this disclosure, the term “impact” may refer to any determinable impact, or possible impact, on the user (e.g., the business of a customer or client of the software offering provider) or the software offering provider, including adverse impacts, such as downtime, monetary loss, contract cancellations, or the like. Contextual dependencies between the reported issue and one or more context attributes may be considered to determine an estimated impact associated with a reported issue.

In some examples, the second priority rating differs from the first priority rating generated for the reported issue. For example, the first priority rating may be “medium,” while the second priority rating is “high” or “urgent,” based on context data discovered and analyzed using techniques described herein. In some examples, the second priority rating is an adjusted version of the first priority rating, based on the context data. In other examples, the second priority rating and the first priority rating are separate ratings.

The second priority rating may be presented at a computing device, optionally together with the first priority rating via a GUI. In some examples, a GUI is provided to present an issue dashboard. The issue dashboard may display a plurality of issues and one or more priority ratings.

Accordingly, examples described herein may allow for the automatic augmentation, enhancement, or enrichment of data relating to an issue with context data. This may enable an issue tracking system to provide improved, automatic prioritization or processing of an issue, e.g., by providing a more objective and useful rating of an urgency of the issue relative to other issues in an issue queue. Such prioritization may better account for various factors, such as the possible business impact associated with the issue, e.g., business cost of failing to address the issue.

In some examples, a useful and efficient “augmented context discovery” service or tool is provided. When implemented, the service or tool automatically identifies relations between a reported issue and one or more context attributes, considers dependencies or interconnections between issues and context information, and generates priority ratings. In this way, examples of the present disclosure may reduce processing or resolution time associated with issues that have a high, or relatively high, business impact. Examples of the present disclosure may thus improve an automated or partially automated development support process or other issue handling process.

Examples described herein may improve the functioning of a computer by improving automatic prioritization and resource allocation, e.g., within a computer implementing an issue tracking system. When the effects in this disclosure are considered in aggregate, one or more of the methodologies described herein may obviate a need for certain efforts or resources that otherwise would be involved in issue tracking or issue handling in the context of software offerings. Computing resources utilized by systems, databases, or networks may be more efficiently utilized or reduced, e.g., as a result of improved automatic priority ratings that obviate or reduce the need to perform manual adjustments of priority ratings, or as a result of a reduction in average processing times or network communications associated with important or critical issues. Examples of such computing resources may include processor cycles, network traffic, memory usage, graphics processing unit (GPU) resources, data storage capacity, power consumption, and cooling capacity.

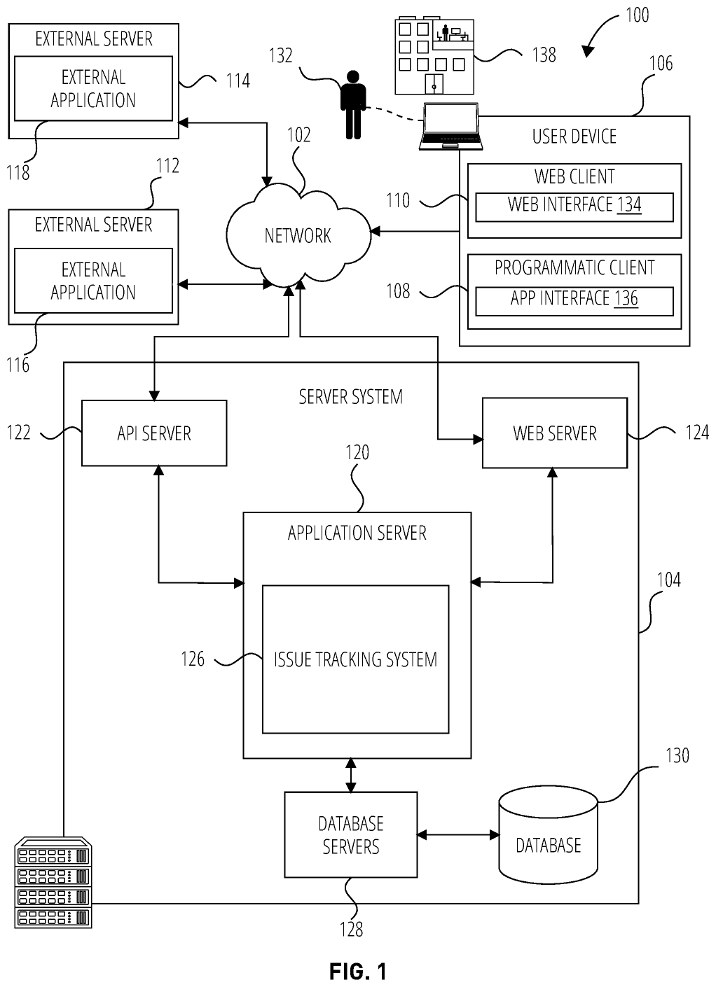

FIG. 1 is a diagrammatic representation of a networked computing environment 100 in which some examples of the present disclosure may be implemented or deployed. One or more servers in a server system 104 provide server-side functionality via a network 102 to a networked device, in the example form of a user device 106 that is accessed by a system user 132. A web client 110 (e.g., a browser) or a programmatic client 108 (e.g., an “app”) may be hosted and executed on the user device 106.

An Application Program Interface (API) server 122 and a web server 124 provide respective programmatic and web interfaces to components of the server system 104. A specific application server 120 hosts an issue tracking system 126, which includes components, modules, or applications.

The user device 106 can communicate with the application server 120, e.g., via the web interface supported by the web server 124 or via the programmatic interface provided by the API server 122. It will be appreciated that, although only a single user device 106 is shown in FIG. 1, a plurality of user devices may be communicatively coupled to the server system 104 in some examples. Further, while certain functions may be described herein as being performed at either the user device 106 (e.g., web client 110 or programmatic client 108) or the server system 104, the location of certain functionality either within the user device 106 or the server system 104 may be a design choice.

The application server 120 is communicatively coupled to database servers 128, facilitating access to one or more information storage repository, e.g., a database 130. In some examples, the database 130 includes storage devices that store information to be processed by the issue tracking system 126, e.g., data records of reported issues and at least some of the context data referred to in the examples provided herein.

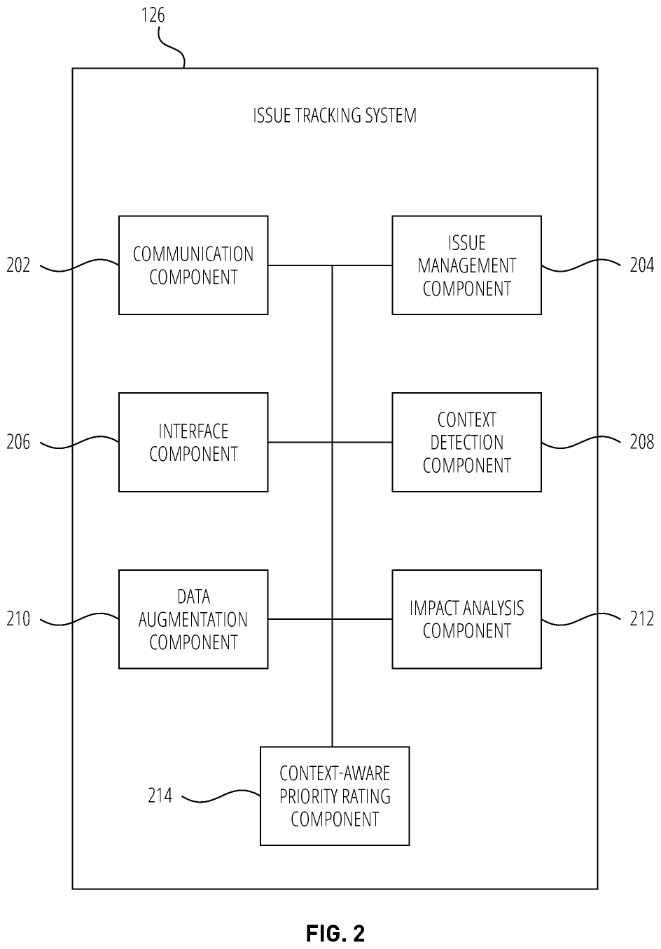

The application server 120 accesses application data (e.g., application data stored by the database servers 128) to provide one or more applications or software tools to the user device 106 via a web interface 134 or an app interface 136. As described further below according to examples and with specific reference to FIGS. 2-8, the application server 120, using the issue tracking system 126, may provide one or more tools or functions for tracking and managing issues relating to software offerings, such as software products or software services provided by a software offering provider, e.g., the software provider 138.

The issue tracking system 126 may assist the system user 132 to create, manage, maintain, adjust, or address issues via the user device 106. The issues may include one or more of bugs, defects, availability or connectivity issues, testing or deployment problems, enhancement requests, and development requests. It will be appreciated, however, that these issues are merely provided as examples and are not intended to be an exhaustive indication of possible issues that are trackable or addressable via the issue tracking system 126.

The issue tracking system 126 may provide one or more dashboards via a GUI on the user device 106, e.g., a dashboard that summarizes a current status of each of a plurality of issues. The issues may, for example, be issues that relate to a user of the software provider 138, e.g., a business that uses one or more software offerings of the software provider 138 as a client of the software provider 138.

The software provider 138 may provide a plurality of software offerings and the user may use one or more of those software offerings. For example, the user may consume multiple instances of (connected or separated) software products as part of services provided by the software provider 138 to the user. Where the user utilizes multiple software offerings of the software provider 138, the software provider 138 may have access to issues originating across different software offerings, or different instances utilized by the user. In some examples, the issue tracking system 126 provides the ability for both the user and the software provider 138 to track or manage the issues. Accordingly, the system user 132 depicted in FIG. 1 may be associated with the software provider 138 or with a client or customer of the software provider 138.

The issue tracking system 126 may further provide functionality to create new issues (e.g., submit or add issue reports), add issue metadata to a report or a reported issue, or track issue progress over time. The issue tracking system 126 may include reporting functionality to enable the system user 132 to generate issue-related reports. Further, and as described further below with reference to FIGS. 2-8, the issue tracking system 126 may provide “augmented context discovery” functionality. The issue tracking system 126 may be configured to analyze reported issues, automatically identify context data relevant to the reported issues, and generate priority ratings for the reported issues.

In some examples, the application server 120 is part of a cloud-based platform provided by the software provider 138 that allows the system user 132 to utilize the tools of the issue tracking system 126. For example, the account holder may create, manage, and track issues by accessing one or more cloud instances. The issue tracking system 126 may receive, access, or retrieve data from various sources, such as internal systems of the server system 104 or external systems, as described further below, to obtain or generate data records pertaining to issues.

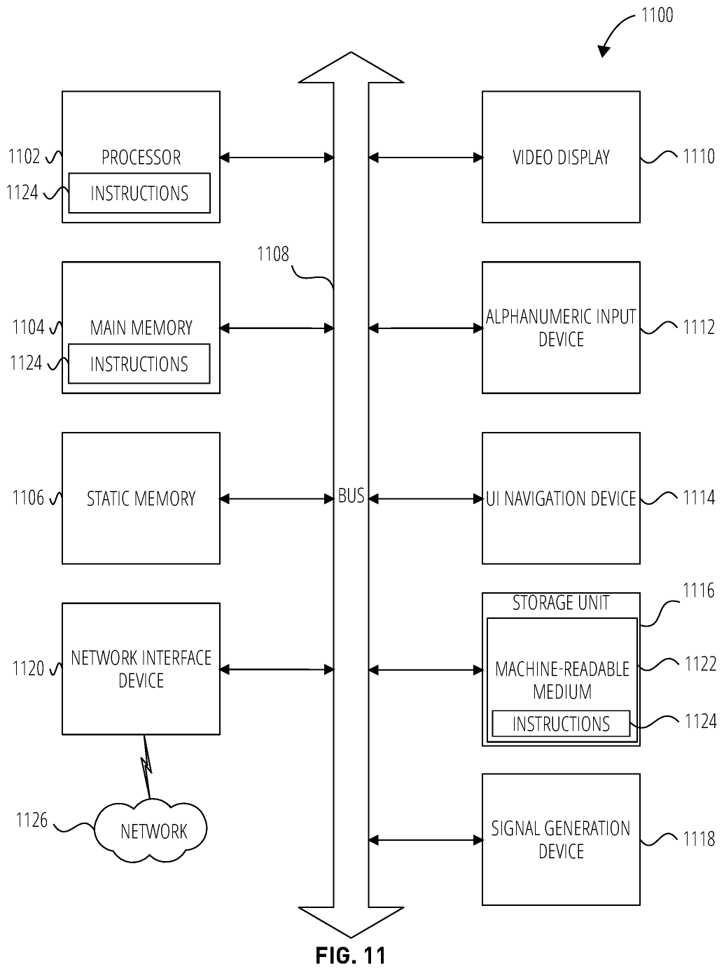

One or more of the application server 120, the database servers 128, the API server 122, the web server 124, and the issue tracking system 126 may each be implemented in a computer system, in whole or in part, as described below with respect to FIG. 11. In some examples, external applications (which may be third-party applications or applications provided by the software provider 138), such as an external application 116 executing on an external server 112 and external application 118 executing on an external server 114, can communicate with the application server 120 via the programmatic interface provided by the API server 122. For example, a third-party application may support one or more features or functions on a website or platform hosted by a third party, or may perform certain methodologies and provide input or output information to the application server 120 for further processing or publication.

As an example, the issue tracking system 126 can be linked to multiple external issue or risk tracking systems in order to receive data relating to issues from these multiple external systems. The external application 116 and the external application 118 may be applications of different service providers, and the issue tracking system 126 may receive details of reported issues (e.g., data records of reported issues) from the service providers via the external server 112 and the external server 114, respectively. In this way, the issue tracking system 126 may provide a holistic or integrated view of issues that pertain to a specific entity (e.g., a customer or client of the software provider 138) or to a specific software offering, which may in turn enable better resource allocation or issue prioritization. Examples of applications that provide issue tracking or risk tracking functionality include ServiceNow™, Jira™, Bugzilla™, and SAP Business Continuity Planning (BCP)™.

The network 102 may be any network that enables communication between or among machines, databases, and devices. Accordingly, the network 102 may be a wired network, a wireless network (e.g., a mobile or cellular network), or any suitable combination thereof. The network 102 may include one or more portions that constitute a private network, a public network (e.g., the Internet), or any suitable combination thereof.

FIG. 2 is a block diagram illustrating certain components of the issue tracking system 126, according to some examples. The issue tracking system 126 is shown to include a communication component 202, an issue management component 204, an interface component 206, a context detection component 208, a data augmentation component 210, an impact analysis component 212, and a context-aware priority rating component 214.

In some examples, at least some of the components shown in FIG. 2 are configured to communicate with each other to implement aspects described herein. Any one or more of the components described herein may be implemented using hardware (e.g., one or more processors of one or more machines) or a combination of hardware and software. For example, any component described herein may be implemented by a processor configured to perform the operations described herein for that component. Moreover, any two or more of these components may be combined into a single component, or the functions described herein for a single component may be subdivided among multiple components. Furthermore, according to various examples, components described herein may be implemented using a single machine, database, or device, or be distributed across multiple machines, databases, or devices.

The communication component 202 receives data sent to the issue tracking system 126 and transmits data from the issue tracking system 126. For example, the communication component 202 may receive, from the external server 112, data records of reported issues that relate to a software offering provided to a user by the software provider 138. Further, the communication component 202 may receive user input, such as instructions for processing or adjusting reported issues, or instructions for managing an issue queue, originating from the user device 106. The communication component 202 may transmit data to the user device 106, e.g., reports that include details of issues, reminders, or other notifications. In some examples, the issue tracking system 126 is configured to receive requests and other data via API calls and return responses and results via the communication component 202.

The issue management component 204 generates a list of issues and dynamically tracks and updates the status of each issue. Issues may be manually reported issues, e.g., by a user or internally by the software provider 138 (e.g., by a development team). Certain internal incidents may be automatically generated, e.g., based on health checks for investigation of detected infrastructure or runtime issues. Similarly, an issue may relate to development requirements that are based on automatically detected incidents, e.g., in a service instance used by the user.

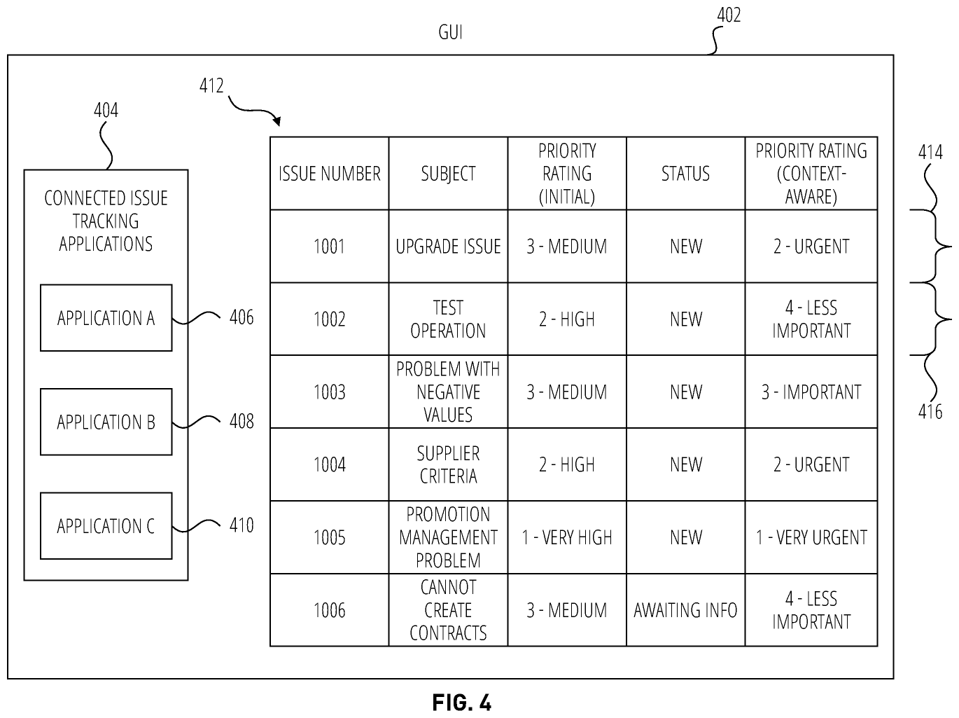

As mentioned, the issue tracking system 126 may aggregate issues from different sources, e.g., the issue management component 204 may retrieve issue reports generated by multiple issue tracking systems and generate a consolidated list, or issue queue, to facilitate processing or management of the issues. The interface component 206 is responsible for providing various GUIs that enable the system user 132 to interact with the issue tracking system 126. Examples of such GUIs are shown in FIGS. 4, 7, and 8 and described below.

The context detection component 208 is configured to identify, discover, or retrieve context data associated with a reported issue. For example, the context detection component 208 may use issue metadata forming part of a data record of a reported issue to identify a relation between the reported issue and context data in one or more context data sources, e.g., data stored in the database 130. The context data may then be retrieved for downstream use, e.g., by the data augmentation component 210.

As mentioned, the context data may include data associated with one or more context attributes. The context attributes may include one or more of:
An initial priority rating of the reported issue;
An escalation status of the reported issue;
Other reported issues associated with the user, e.g., cases reported by the same customer or internal incidents of the software provider 138 relating to the same customer;
Other software offerings provided to the same user;
Other instances of software offerings provided to the same user;
User contractual data, e.g., details of certain terms that should be adhered to in processing incidents;
Business opportunities, e.g., upcoming contract renewals for the user or potential new contracts for services or products provided by the software provider 138;
Availability of the software offering forming the subject of the reported issue;
Usage of the software offering forming the subject of the reported issue;
Availability of other software offerings provided to the same user;
Usage of other software offerings provided to the same user;
Runtime environment data of the software offering forming the subject of the reported issue; or
Runtime environment data of other software offerings provided to the same user.

The issue metadata in the data record of a reported issue may include a user identifier. For example, the issue tracking system 126 may obtain an identifier from a “digital passport” of a user, e.g., a client certificate installed in a browser and used as an authentication tool. The “digital passport” may, for example, identify the specific customer of the software provider 138 that the reported issue relates to. The issue metadata is then used to identify a link to one or more context attributes. The issue tracking system 126 is configured, in some examples, to identify interdependent services with respect to the product or service forming the subject of the reported issue. For example, runtime information can be accessed to obtain component identifiers of one or more product or service components. In some cases, dependencies between products or services are modeled within the issue tracking system 126 or a related system, and the context detection component 208 may access the relevant storage component to retrieve the dependencies.

In this way, the context detection component 208 may detect relations, interconnectivity, or dependencies, between different components, products, or services. For example, the user may have a first instance of a database software offering that depends on a second instance of the database software offering in order to remain operational. The context detection component 208 may detect the second instance using issue metadata contained in a data record of a reported issue concerning the first instance.

The context detection component 208 may automatically assess technical or commercial properties of, or associated with, certain context of a reported issue. For example, from a technical perspective, the context detection component 208 may analyze the size or usage of a service instance and its related or connected components, e.g., to determine memory consumption, processing component usage, file server information, transaction volume, and so forth. From a commercial perspective, the context detection component 208 may analyze running costs, contract costs, downtime costs, contractual terms and conditions, and so forth associated with a service, product, or component of a user. The technical or commercial information may thus form part of the context data detected or retrieved by the context detection component 208.

The data augmentation component 210 is responsible for augmenting or enriching the issue metadata contained in the data record of the reported issue with the relevant context data. For example, the issue metadata may contain a user identifier, and the context detection component 208 may retrieve user data matching the user identifier from the database 130, such as details of a user's contract with the software provider 138 or details of other issues reported by the user with respect to related service software offerings. The data augmentation component 210 may then augment or enrich the issue metadata with relevant additional details from the context data. In some examples, the augmented issue metadata is stored in the database 130.

The impact analysis component 212 is configured to analyze the reported issue, together with the context data, to estimate an impact associated with the reported issue. As described above, the impact may be an estimated business impact associated with a failure to address the reported issue. For example, the impact analysis component 212 may determine, based on the context data, that a continued outage of a first service instance of a user would have a knock-on effect on another service instance of the user, causing a second outage. The impact analysis component 212 may further estimate a commercial (e.g., monetary or contractual) impact of such effects on the user, on the software provider 138, or on both the user and the software provider 138. Output of the impact analysis component 212 may be expressed in various structures or formats, e.g., an impact score or a monetary value. Example techniques for determining impact scores are described below.

The context-aware priority rating component 214 generates a priority rating for the reported issue based on the context data. The context-aware priority rating component 214 may base the priority rating on the augmented issue metadata, on output of the impact analysis component 212, or both. As mentioned, in some examples, the data record of the reported issue contains an “initial” priority rating, e.g., assigned as part of an initial issue logging process within the issue tracking system 126. In some examples, the priority rating generated by the context-aware priority rating component 214 is therefore a second priority rating, or adjusted priority rating, reflecting the impact of the context as assessed by the issue tracking system 126. However, in other examples, the priority rating generated by the context-aware priority rating component 214 is the only priority rating generated for a reported issue within the context of the issue tracking system 126.

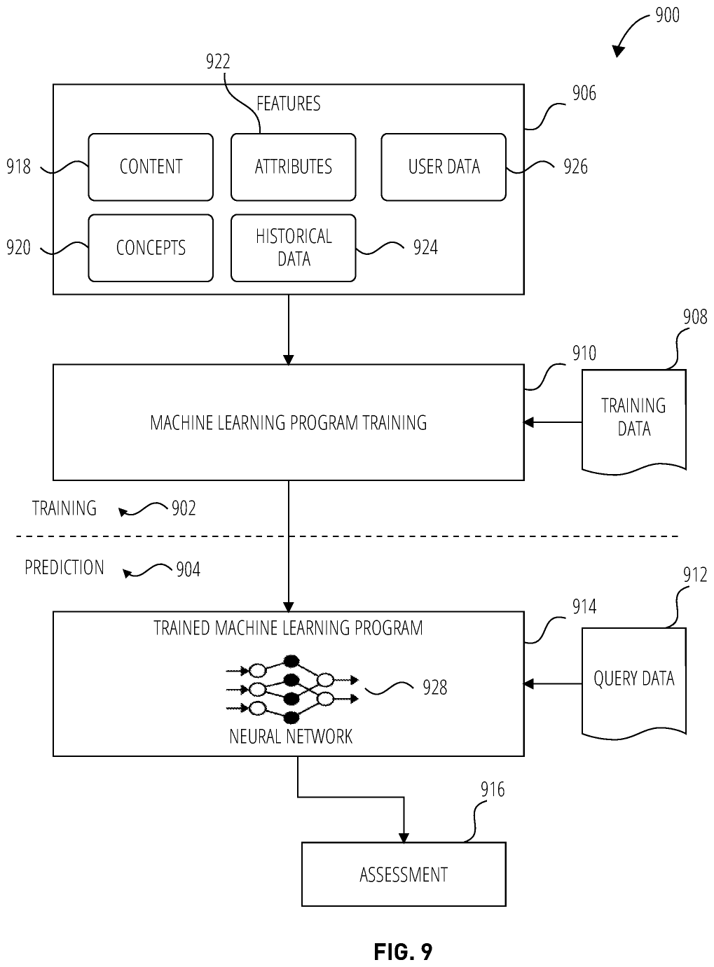

The issue tracking system 126 may implement a rules engine to generate, for example, the estimated impact of a reported issue or the “context-aware” priority rating. The issue tracking system 126 may also implement a rules engine to identify and retrieve the context data. Alternatively or additionally, one or more of these aspects may be implemented by utilizing machine learning techniques. As an example, a machine learning model may be trained using training data that includes priority ratings and corresponding issues, together with respective context data that influenced each priority rating. In this way, the machine learning model may be trained to analyze a given set of context data associated with a given reported issue (which may include an “initial” priority rating) and generate a predicted priority rating (or a predicted adjustment to be made the “initial” priority rating based on the context data). Example machine learning techniques are further described below, with reference to FIG. 9.

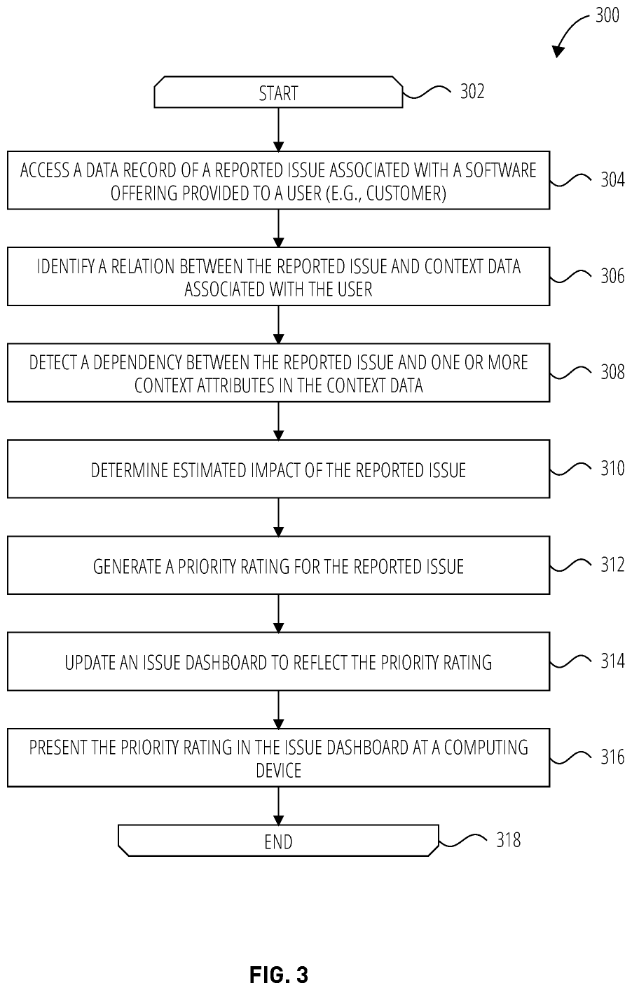

FIG. 3 is a flowchart illustrating operations of a method 300 suitable for identifying and using context data to generate a priority rating for a reported issue, according to some examples. By way of example and not limitation, aspects of the method 300 may be performed by the components, devices, systems, network, or databases shown in FIG. 1 and FIG. 2.

The method 300 commences at opening loop element 302 and proceeds to operation 304 where the issue tracking system 126 accesses a data record of a reported issue associated with a software offering. For example, the software offering may be a service instance provided, as a cloud solution, by the software provider 138, and utilized by the user. The reported issue may be one of a plurality of reported issues handled by the issue tracking system 126, e.g., the reported issue may be an update issue that requires patches to be delivered.

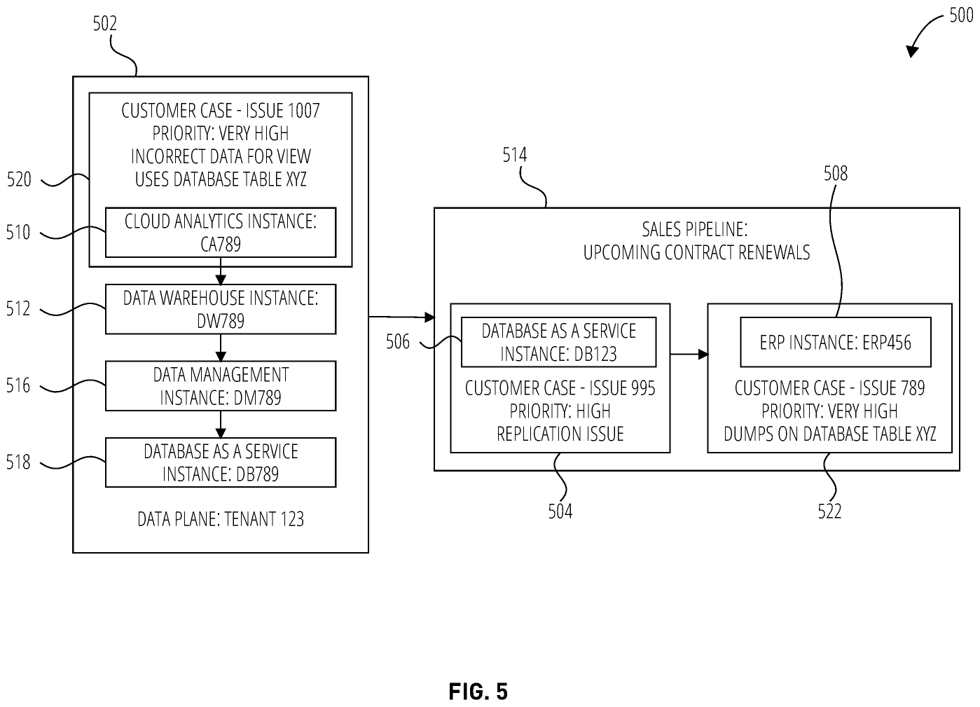

At operation 306, the issue tracking system 126 identifies a relation between the reported issue and context data. The issue tracking system 126 uses metadata in the data record of the reported issue to identify the relation. For example, the issue tracking system 126 may use a user identifier to locate other service instances of the user, or other reported issues submitted by the user. To determine such relations, data matching or data identification operations, such as those described with reference to FIG. 4 and FIG. 5, may be performed.

The method 300 proceeds to operation 308, where the issue tracking system 126 detects a dependency between the context data and the reported issue. The dependency may be indicative of an interconnection between the reported issue and some other issue or context attribute, which could lead to the reported issue having an effect on the other issue or context attribute. The context may indicate, for example, that the user could suffer monetary loss if the patches are not delivered in a certain timeframe, that the software provider 138 would be in breach of a contract with the user if the patches are not delivered in a certain timeframe, or that failure to deliver the patches could cause an outage of a connected service instance provided to the user by the software provider 138. Accordingly, the issue tracking system 126 identifies a connection, dependency, or other link between the reported issue itself and other factors that have (or may have) a bearing on the user.

The context data may also include other data that does not directly relate to dependencies or interconnections. For example, the context data may include an escalation status of the reported issue. The escalation status may indicate whether the reported issue has been escalated or followed-up on, or whether a second report has been submitted or logged with respect to the same issue. The context data may also include system or service information, such as whether the system is productive or in a testing mode, expected end of life/service, and so forth.

Generally, in some examples, identification of interdependent product and service types can be effected using a user identifier or instance identifier (the instance identifier may be included in a data record of a reported issue based on software provisioning services). Runtime performance indicators may be obtained from the runtime environment associated with a product or service, e.g., infrastructure size, health, connectivity configurations, and so forth. Upcoming business opportunities, such as sales or renewal opportunities, can be obtained from a customer relationship management (CRM) system that is communicatively coupled to the issue tracking system 126.

Referring again to FIG. 3, the issue tracking system 126 determines an estimated impact of the reported issue at operation 310. For example, to generate such an estimated impact, the issue tracking system 126 uses the impact analysis component 212 in the manner described above. A priority rating for the reported issue is then generated at operation 312. This priority rating may be referred to as a “context-aware” priority rating, as it is the result of the identification and analysis of the context data associated with the reported issue.

As mentioned, the issue tracking system 126 may provide one or more GUIs to enable the system user 132 to interact with the issue tracking system 126. At operation 314, the issue tracking system 126 updates an issue dashboard to reflect the priority rating, and the priority rating is presented in the issue dashboard via a suitable GUI at a computing device, such as the user device 106, at operation 316. The issue dashboard may provide an integrated view of a plurality of reported issues, as described with reference to FIG. 4 below. The method 300 concludes at closing loop element 318.

FIG. 4 is a user interface diagram illustrating a GUI 402 of the issue tracking system 126, according to some examples. In FIG. 4, the GUI 402 presents an issue dashboard. The issue tracking system 126 accesses reported issues originating from different issue tracking applications that are connected to the issue tracking system 126, and presents them in the issue dashboard. Examples of the connected issue tracking applications 404 are shown in FIG. 4 as application A 406, application B 408, and application C 410, respectively.

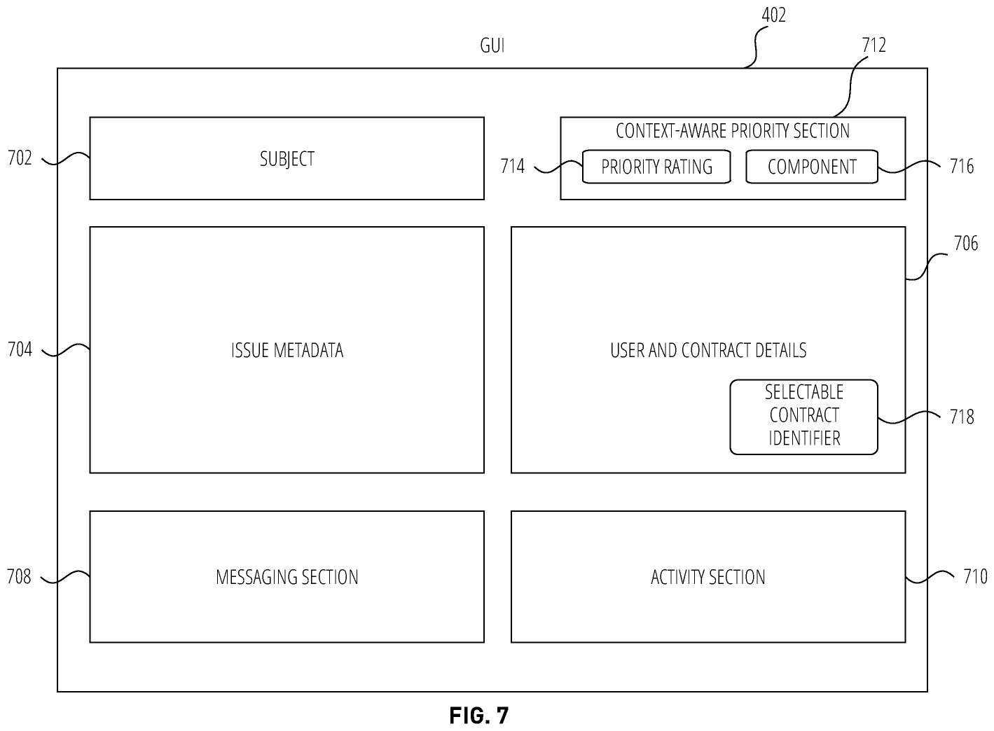

Within the issue dashboard, the reported issues are shown in an issue table 412. The issue table 412 is dynamically updated to reflect reported issues and their respective statuses. In the GUI 402 of FIG. 4, each issue is identified by an issue identifier in the form of an issue number, and is displayed together with a subject, a first priority rating in the form of an “initial” priority rating, and a second priority rating in the form of a “context-aware” priority rating. The system user 132 may select a reported issue from the issue table 412 to view further details of the reported issue, as described with reference to FIG. 7 below.

In the example of FIG. 4, the initial priority rating is selected from very high (1), high (2), medium (3), and low (4), and the context-aware priority rating is selected from very urgent (1), urgent (2), important (3), and less important (4). In other examples, however, the initial and context-aware priority rankings may have identical scale descriptors.

Referring to a first reported issue 414 shown in FIG. 4 (issue number “1001”), the first reported issue 414 has an initial priority rating of “medium” and relates to an upgrade issue experienced by a user. In this case, the issue tracking system 126 automatically detects an interrelated issue associated with the same user that has an impact on a productive scenario of the user waiting to be upgraded. For example, the issue tracking system 126 may detect a related issue for patch implementation with a “very high” priority and an unresolved resolution status. The issue tracking system 126 determines, based on this context, that the first reported issue 414 may lead to, or exacerbate, a current delay experienced by the user. The issue tracking system 126 may also assess user contract data and detect that such a delay may violate, for example, a service level agreement (e.g., requiring 99.5% availability of the relevant service or stipulating a maximum issue processing time).

Based on the context (and, in some examples, also based on the initial data record of the reported issue, e.g., its description and initial priority rating), the issue tracking system 126 determines that the first reported issue 414 may have a significant adverse impact on the business operations of the user, on business of the software provider 138, or both, and generates a context-aware priority rating of “urgent.” This may be interpreted to mean that the issue tracking system 126 determines the first reported issue 414 to require more urgent intervention than initially perceived or stated, e.g., by a person logging the first reported issue 414. This may assist the system user 132 in better managing the first reported issue 414 by assigning appropriate resources or imposing the appropriate timeframe for resolution. In some cases, the issue tracking system 126 may automatically adjust a resource allocation based on the context-aware priority rating.

Referring now to a second reported issue 416 shown in FIG. 4 (issue number “1002”), the second reported issue 416 has an initial priority rating of “high” and relates to a test operation of a service instance (non-productive). The initial priority rating of “high” was assigned by the user making use of the service instance. The issue tracking system 126 determines that the relevant service instance is non-productive and only used for testing purposes, and that the business impact on the user may thus be relatively minor. Based on this context, the issue tracking system 126 automatically assigns a context-aware priority rating of “less important” to the second reported issue 416.

The context-aware priority rating may therefore be indicative of an urgency of a reported issue relative to other reported issues, e.g., in an issue queue. In some examples, the issue tracking system 126 automatically updates (e.g., filters or sorts) the reported issues in the issue table 412 based on their urgency in accordance with the respective context-aware priority ratings, and displays the updated issue queue via the GUI 402. The issue tracking system 126 may thus adjust a position of a reported issue within an issue queue based on the context-aware priority rating, e.g., adjust the position from an initial position determined by the initial priority rating to an adjusted position that reflects the context-aware priority rating.

In some examples, the context data used to assign the priority rating to a reported issue is accessible and reviewable. For example, in the GUI 402 of FIG. 4, the system user 132 may be able to select a link associated with the first reported issue 414, which then reveals or causes transmission, to the user device 106, of the context data upon which the priority rating is based.

As described above, the issue tracking system 126 may identify one or more relations or one or more contextual dependencies between a reported issue and context data. The issue tracking system 126 may form part of a larger system of the software provider 138, with the software provider 138 providing various software offerings that can be consumed by users. The software offerings, e.g., various instances of different software solutions, associated with a particular user (e.g., a particular customer or client of the software provider 138) can be modeled within the system of the software provider 138 to enable the issue tracking system 126 to identify related products, services, instances, or components.

FIG. 5 is a relationship diagram 500 illustrating relations between multiple reported issues, as well as context data, according to some examples. In the example of FIG. 5, a user, e.g., a customer of the software provider 138, utilizes various software offerings provided by the software provider 138. A first reported issue 504 (issue “995”) is reported with respect to a database as a service instance 506 used by the user. In this case, the first reported issue 504 is a replication issue that has been assigned an initial priority rating of “high.” The issue tracking system 126 accesses various repositories and runtime environments, e.g., via access APIs and using context matching based on a rules engine or machine learning model, to obtain context data relating to the first reported issue 504.

Firstly, the issue tracking system 126 detects that the database as a service instance 506 is a relatively large, productive instance that is linked to an enterprise resource planning (ERP) instance 508. The issue tracking system 126 further determines, by accessing a repository (e.g., in the database 130) containing a sales pipeline 514 with business opportunity data, that the user has upcoming contract renewals for both the database as a service instance 506 and the ERP instance 508.

The issue tracking system 126 determines that the database as a service instance 506 is accessed in a data plane 502 (“tenant 123”) that includes a cloud analytics instance 510, a data warehouse instance 512, a data management instance 516, and an associated database as a service instance 518, all linked to the same user (e.g., customer). Further, the issue tracking system 126 determines that the same user reported a second reported issue 520 (issue “1007”) with an initial priority rating of “very high” for development support with respect to the cloud analytics instance 510. The second reported issue 520 was submitted and allocated to a development support component associated with the data warehouse instance 512 for further analysis.

In addition to the second reported issue 520, the issue tracking system 126 determines that the same user reported a third reported issue 522 (issue “789”) with an initial priority rating of “very high” with respect to the ERP instance 508. The issue relates to a remote database table (“XYZ”) which matches a database table associated with the cloud analytics instance 510, with the associated user being the database as a service instance 506.

Accordingly, the issue tracking system 126 performs “augmented context discovery” to obtain context data from multiple context data sources associated with the user. The context data is retrieved and analyzed to determine a context-aware priority rating, e.g., in the manner described above. Referring specifically to the example scenario of FIG. 5, given the “nested” issues identified by the issue tracking system 126 (including the second reported issue 520 and the third reported issue 522), the upcoming contract renewal opportunities, as well as the usage data indicating that the database as a service instance 506 is productive and relatively large, the issue tracking system 126 allocates a context-aware priority rating of “very urgent” to the first reported issue 504. This priority rating is communicated to the appropriate support team, e.g., automatically surfaced in the issue dashboard of the GUI 402 of FIG. 4, and positioned in an issue query base on its “very urgent” rating.

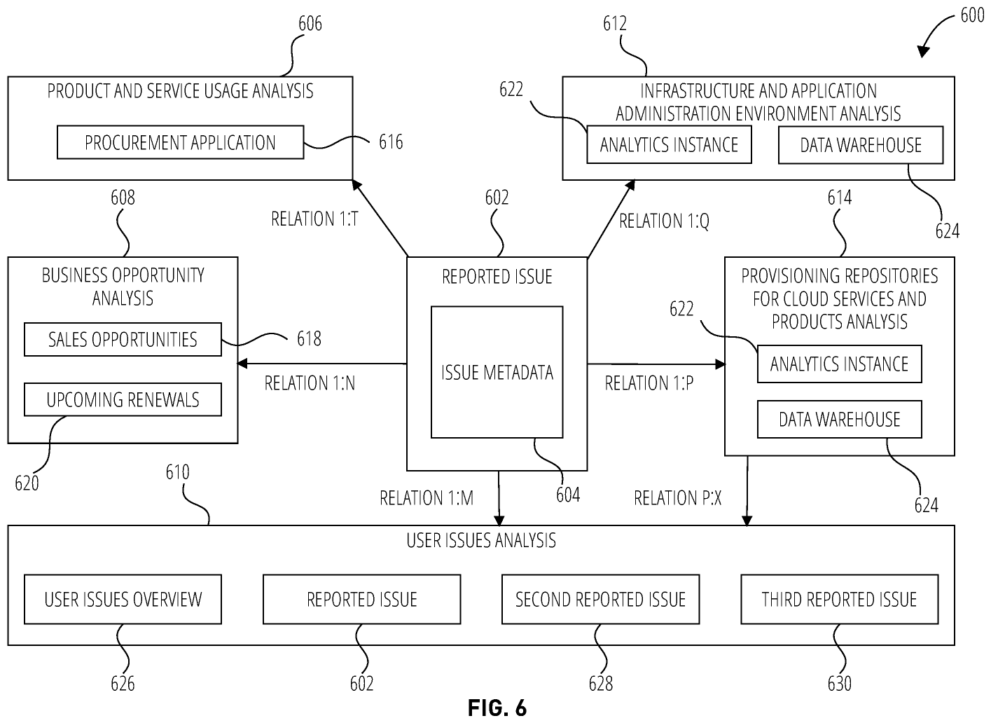

FIG. 6 is a block diagram in the form of an interaction diagram 600, illustrating the manner in which the context detection component 208 interacts with multiple context data sources to identify or retrieve context data relating to various context attributes, according to some examples. The description of FIG. 6 below includes examples of data items that may be included as part of issue metadata or context attribute data. It will be appreciated that examples of the present disclosure may include any one or more of the data items mentioned in the examples, or may include other data items not explicitly mentioned in the examples.

The interaction diagram 600 illustrates a reported issue 602. The reported issue 602 has a data record that includes issue metadata 604, as described above. In the example of FIG. 6, the issue metadata 604 includes: a user identifier, a reported issue identifier, a service instance identifier, a support component identifier, a contract identifier, a contract due date, an initial priority rating, a system type (e.g., productive or testing), an escalation status, and an issue description.

It is noted that the term “user identifier” may refer to any identifier that may be associated with a user and that can be used to identify or locate details of the user. The “user” may be a business entity that is a customer or client of the software provider 138, a specific subsidiary or unit of such a business entity, or an individual user within such a business entity, while the “identifier” may be a number, a code, a name (e.g., business name or username), or the like.

The context detection component 208 of the issue tracking system 126 utilizes data forming part of the issue metadata 604 to identify corresponding context data in various repositories. For example, the context detection component 208 may match the user identifier with other records containing the user identifier, or the service instance identifier with other records containing the service instance identifier. The context detection component 208 may access various different repositories and runtime environments with relations, or links, to the reported issue 602. The context detection component 208 may be implemented in complex environments or networks, e.g., where context data is sourced from different domains, such as provisioning, finance, infrastructure administration, usage analysis, and so forth. Examples of such relations and analyses are provided below.

In some examples, the context detection component 208 is configured to extract or infer additional issue metadata from an initial set of information, e.g., from an initial set of issue metadata that includes one or more of a user identifier, an issue description, or an issue topic. The context detection component 208 may extract or infer additional issue metadata by accessing related issues, e.g., issues with the same topic as the reported issue in question. In this way, the context detection component 208 may be able to gather a larger set of relevant, or potentially relevant, context data. One or more machine learning models, e.g., as described with reference to FIG. 9 below, may be used for such extraction or inference. The additional issue metadata ma then be used for further context detection, retrieval, or analysis.

As identified by the arrow marked “relation 1:t” in FIG. 6, the context detection component 208 performs a product and service usage analysis 606 and identifies a relevant application in the example form of a procurement application 616. A record of the procurement application 616 may include the user identifier and usage details, such as total call traffic. The context detection component 208 may identify that there is a contextual dependency between the reported issue 602 and the procurement application 616, and consider context data of the procurement application 616 to generate a context-aware priority rating. While only one example application is shown in FIG. 6, it is noted that the label “relation 1:t” indicates that the reported issue may, at least in some examples, have an effect or impact on (e.g., impact the functionality of) “t” products or services, which may be more than one application.

The context detection component 208 performs a business opportunity analysis 608 by checking sales opportunities 618 and upcoming renewals 620 (e.g., contract renewals) associated with the user identifier in the issue metadata 604 (relation 1:n). The issue tracking system 126 may, as described above, determine a business impact and a context-aware priority rating associated with the reported issue 602 based at least partially on the business opportunity analysis 608. Again, it is noted that the label “relation 1:n” indicates that the reported issue may, at least in some examples, endanger or otherwise impact “n” business opportunities, which may be multiple opportunities, such as contract renewals.

The context detection component 208 further performs a user issues analysis 610. The context detection component 208 may access a repository of reported issues (relation 1:m). The repository may include a user issues overview 626, e.g., a data record indicating the user identifier, number of reported issues, number of escalations, and so forth. The context detection component 208 may also access the data records of specific reported issues, such as a second reported issue 628 and a third reported issue 630. Where other reported issues are dependent on, or may be impacted by, the reported issue 602, the issue tracking system 126 uses the context data relating to the other reported issues to determine the context-aware priority rating. Again, it is noted that the label “relation 1:m” indicates that the reported issue may be related to “m” further issues.

In some cases, during the user issues analysis 610, the context detection component 208 may consider not only other reported issues of the same user, but also other reported issues that are deemed to be related to the reported issue 602. For example, the context detection component 208 may identify an issue with the same, or similar, description or support notes as the reported issue 602, and utilize a data record of that issue as context data.

As shown at “relation 1:q” in FIG. 6, the context detection component 208 performs an infrastructure and application administration environment analysis 612. For example, and as shown in FIG. 6, the context detection component 208 identifies an analytics instance 622 and a data warehouse 624 used by the user corresponding to the reported issue 602, e.g., by matching data from the issue metadata 604 to records of the analytics instance 622 and the data warehouse 624. As part of the infrastructure and application administration environment analysis 612, the context detection component 208 may retrieve context data relating to these components, such as health check data, cloud instance data, or user contract details relating to each component (e.g., required availability as per a service level agreement). Again, it is noted that the label “relation 1:q” indicates that the reported issue may be related to “q” infrastructure or application components.

The context detection component 208 also performs a provisioning repositories for cloud services and products analysis 614 (“relation 1:p”). Here, the context detection component 208 again identifies the analytics instance 622 and the data warehouse 624, but is able to retrieve additional context data, such as business type (e.g., “productive tenant”), tenant information, provisioning status, or the like. Again, it is noted that the label “relation 1:p” indicates that the reported issue may be related to “p” services or products.

Context data retrieved during the infrastructure and application administration environment analysis 612 or the provisioning repositories for cloud services and products analysis 614 may similarly be used to generate a context-aware priority rating or estimate a business impact of the reported issue 602. It is noted that the arrow marked “relation p:x” in FIG. 6 indicates that, in some examples, it is not only a direct relation between a reported issue and one or more context attributes, but also an indirect relation, that may be identified and utilized by the issue tracking system 126 to perform techniques described herein.

As mentioned, in some examples, an impact score may be generated in the process of determining a context-aware priority rating. In some cases, e.g., in the example of FIG. 6, the context detection component 208 retrieves context data relating to a plurality of context attributes (e.g., business opportunities, user issues, and usage analysis). In such cases, the priority rating may be determined, e.g., by the impact analysis component 212, by generating an impact score for each context attribute, aggregating the impact scores to obtain an aggregated impact score, and then determining the second priority rating based on the aggregated impact score.

For example, to calculate a particular priority rating based on different sets of context data (Cx), a value for each Cx is converted into a weight factor (Wx). Wx can then be converted to a result in a relevant result range (RCx). For example, Wx can be multiplied by a distance factor (DCx), thereby yielding a result range (RCx). Wx may be multiplied by another attribute's Wx as part of the calculation. In order to restrict or prevent an “exploding result range,” a damping function (e.g., arctan) can be applied if needed. The impact scores for the respective sets of context data (e.g., each context attribute), which are the scores in the range RCx for each set of context data, can then be aggregated, e.g., by averaging them, calculating a weighted sum, or applying a more complex function. The priority rating can be generated based on the final result.

A non-limiting example, broadly considering the context attributes “Business Opportunities” and “Customer Case Priority,” is included below: Business Opportunities:
Convert planned new contracts and contract renewals (monetary value) deemed to be contextually dependent on the reported issue into a weight factor.
Multiply the result by a deal (contract) distance factor to obtain the relevant result range.

### Customer Case Priority:

Convert the initial priority rating and escalation status of the reported issue into a weight factor.
Convert an age and expected processing time of the reported issue, as well as its distance (from a time perspective) to a relevant customer contract date, into a weight factor.
Multiply the above weight factors and apply a damping function to obtain the relevant result range.
Aggregate the result range with that for the “Business Opportunities” to obtain the final score for use in generating the context-aware priority rating.

In some examples, the impact analysis component 212 may implement one or more machine learning models to generate impact scores, context-aware priority ratings, or both. For example, a prediction model is a machine learning model that analyzes patterns in historical data and learns to associate those patterns with outcomes. A prediction model may be trained on historical issue and context data to perform numerical prediction, e.g., to generate one or more impact scores for a given reported issue, to generate a context-aware priority rating for a given reported issue, or combinations thereof. The prediction model may learn to associate a reported issue with certain context data with a corresponding priority rating, or range of priority ratings. The description of FIG. 9 below provides further detail with respect to some examples of machine learning models.

FIG. 7 is a user interface diagram illustrating the GUI 402 of the issue tracking system 126, illustrating a reported issue details page, according to some examples. As mentioned, the system user 132 may use the user device 106 to select a specific reported issue, e.g., from within the issue table 412 shown in FIG. 4. Responsive to the selection, the issue tracking system 126 may cause presentation of further details of the reported issue and options that are available with respect to the reported issue.

The GUI 402 of FIG. 7 is shown to include a subject 702, issue metadata 704, and user and contract details 706. The subject 702, the issue metadata 704, or the user and contract details 706 may form part of a stored data record for the reported issue. The subject 702 and the issue metadata 704 may include any one or more of the data items described above. The user and contract details 706 may include contract details, such as details of a current service level agreement, e.g., a key term of the agreement or its termination date.

The GUI 402 presents a messaging section 708 and an activity section 710. The messaging section 708 enables the system user 132 to compose a message within the issue tracking system 126, while the activity section 710 provides an overview of actions taken, e.g., changes made or interventions initiated, with respect to the reported issue.

Further, the GUI 402 presents a context-aware priority section 712. The context-aware priority section 712 provides the system user 132 with an indication of the priority rating 714 generated by the issue tracking system 126 for the specific reported issue, taking into account the context data retrieved by the issue tracking system 126. The context-aware priority section 712 also identifies a component 716, e.g., a relevant service instance that is impacted by, or may be impacted by, the reported issue. In some examples, the priority rating 714 is user-selectable via the GUI 402 to access further details, such as the context information upon which the priority rating 714 is based. The component 716 may also be user-selectable to access further details of the component 716, e.g., its current status or health.

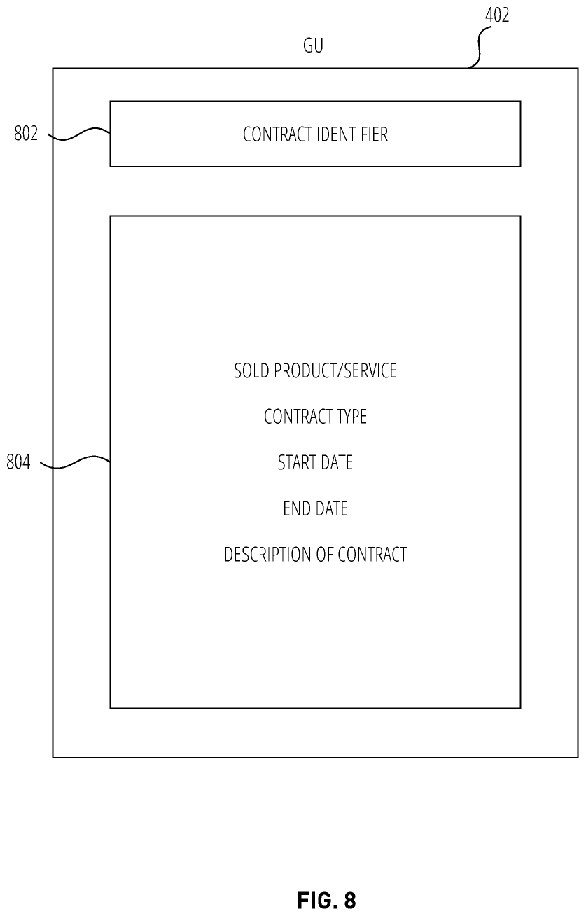

In some examples, user contract details are included in the data record of the reported issue. As shown in FIG. 7, the user and contract details 706 of the GUI 402 includes a selectable contract identifier 718. User selection of the selectable contract identifier 718 causes presentation of more detailed user contract details, such as the details shown in FIG. 8. The details shown in FIG. 8 are intended to illustrate some examples of details that may be included in the data record, and are not intended to be limiting.

The GUI 402 of FIG. 8 shows that user contract details can include a contract identifier 802 (e.g., a unique code or a contract name), as well as the following additional contract details 804: sold product/service, contract type, start date, end date, and a description of the contract. The description of the contract may include details of terms relevant to the issue tracking system 126, such as issue handling timeframes, availability requirements, and the like. Inclusion of user contract details in the data record of the reported issue, or linking of the user contract details to the reported issue in this manner, may facilitate identification or retrieval of context data, and thereby facilitate the automatic generation of context-aware priority ratings.

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one memory that stores instructions; and one or more processors configured by the instructions to perform operations comprising: accessing a data record of a reported issue associated with a software offering provided to a user, the data record comprising issue metadata that includes, a first priority rating for the reported issue; using the issue metadata to identify a relation between the reported issue and context data associated with the user; generating, based on at least the context data, a second priority rating for the reported issue, the second priority rating differing from the first priority rating; and causing presentation of the second priority rating at a computing device.

In Example 2, the subject matter of Example 1 includes, wherein the generating of the second priority rating comprises determining, based on the context data and the data record, an estimated impact associated with the reported issue.

In Example 3, the subject matter of Example 2 includes, wherein the estimated impact is an estimated business impact.

In Example 4, the subject matter of Examples 2-3 includes, wherein the determining of the estimated impact associated with the reported issue comprises detecting a dependency between the reported issue and at least one context attribute in the context data.

In Example 5, the subject matter of Examples 1-4 includes, the operations further comprising: augmenting the issue metadata with the context data to obtain augmented issue metadata, wherein the second priority rating is generated based on the augmented issue metadata.

In Example 6, the subject matter of Examples 1-5 includes, wherein the using of the issue metadata to identify the relation between the reported issue and the context data comprises: determining that data forming part of the issue metadata matches data in one or more context data sources associated with the user; and retrieving the context data from the one or more context data sources.

In Example 7, the subject matter of Example 6 includes, wherein the one or more context data sources comprise at least one of: a data repository storing user data; a data repository storing reported issues; or a runtime environment associated with the user.

In Example 8, the subject matter of Examples 1-7 includes, wherein the reported issue is one of a plurality of reported issues in an issue queue, and the second priority rating is indicative of an urgency of the reported issue relative to other reported issues in the plurality of reported issues.

In Example 9, the subject matter of Example 8 includes, the operations further comprising: adjusting a position of the reported issue within the issue queue based on the second priority rating; and causing presentation of the issue queue at the computing device, the issue queue reflecting the adjusted position of the reported issue.

In Example 10, the subject matter of Examples 1-9 includes, wherein the issue metadata further comprises at least one of: a user identifier; a reported issue identifier; a reported issue description; a software offering identifier; a software offering instance identifier; or an escalation status.

In Example 11, the subject matter of Examples 1-10 includes, wherein the reported issue is a first reported issue, the software offering is a first software offering, and the context data comprises one or more context attributes, the context attributes including at least one of: the first priority rating of the first reported issue; an escalation status of the first reported issue; a further reported issue associated with the user; a further software offering provided to the user; user contractual data; business opportunity data; availability of the first software offering; usage of the first software offering; availability of the further software offering; usage of the further software offering; runtime environment data of the first software offering; or runtime environment data of the further software offering.

In Example 12, the subject matter of Examples 1-11 includes, wherein the context data comprises a plurality of context attributes, and the generating of the second priority rating comprises: generating an impact score for each context attribute; aggregating the impact scores to obtain an aggregated impact score; and determining the second priority rating based on the aggregated impact score.

In Example 13, the subject matter of Examples 1-12 includes, wherein the second priority rating is generated by using at least one of: a processor-implemented rules engine; or a machine learning model that is trained to generate, based on a given reported issue and given context data, a second priority rating for the given reported issue.

In Example 14, the subject matter of Examples 1-13 includes, wherein the causing presentation of the second priority rating at the computing device comprises causing presentation, via a graphical user interface of the computing device that provides an issue dashboard, of the second priority rating together with the first priority rating.

Example 15 is a method comprising: accessing a data record of a reported issue associated with a software offering provided to a user, the data record comprising issue metadata that includes, a first priority rating for the reported issue; using the issue metadata to identify a relation between the reported issue and context data associated with the user; generating, based on at least the context data, a second priority rating for the reported issue, the second priority rating differing from the first priority rating; and causing presentation of the second priority rating at a computing device.

In Example 16, the subject matter of Example 15 includes, wherein the generating of the second priority rating comprises determining, based on the data record and the context data, an estimated impact associated with the reported issue.

In Example 17, the subject matter of Examples 15-16 includes, augmenting the issue metadata with the context data to obtain augmented issue metadata, wherein the second priority rating is generated based on the augmented issue metadata.

Example 18 is a non-transitory computer-readable medium that stores instructions that, when executed by one or more processors, cause the one or more processors to perform operations comprising: accessing a data record of a reported issue associated with a software offering provided to a user, the data record comprising issue metadata that includes, a first priority rating for the reported issue; using the issue metadata to identify a relation between the reported issue and context data associated with the user; generating, based on at least the context data, a second priority rating for the reported issue, the second priority rating differing from the first priority rating; and causing presentation of the second priority rating at a computing device.

In Example 19, the subject matter of Example 18 includes, wherein the generating of the second priority rating comprises determining, based on the data record and the context data, an estimated impact associated with the reported issue.

In Example 20, the subject matter of Examples 18-19 includes, the operations further comprising: augmenting the issue metadata with the context data to obtain augmented issue metadata, wherein the second priority rating is generated based on the augmented issue metadata.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

FIG. 9 is a block diagram showing a machine learning program 900, according to some examples. Machine learning programs, also referred to as machine learning algorithms or tools, may be used as part of the systems described herein to perform one or more operations, e.g., to identify relations between reported issues and context data, to identify contextual dependencies, to extract or infer additional issue metadata using initial issue metadata, to generate priority ratings, to generate estimated impacts, or combinations thereof.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine learning tools operate by building a model from example training data 908 in order to make data-driven predictions or decisions expressed as outputs or assessments (e.g., assessment 916). Although examples are presented with respect to a few machine learning tools, the principles presented herein may be applied to other machine learning tools.

In some examples, different machine learning tools may be used. For example, Logistic Regression (LR), Naive-Bayes, Random Forest (RF), neural networks (NN), matrix factorization, and Support Vector Machines (SVM) tools may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine learning program 900 supports two types of phases, namely training phases 902 and prediction phases 904. In training phases 902, supervised learning, unsupervised or reinforcement learning may be used. For example, the machine learning program 900 (1) receives features 906 (e.g., as structured or labeled data in supervised learning) and/or (2) identifies features 906 (e.g., unstructured or unlabeled data for unsupervised learning) in training data 908. In prediction phases 904, the machine learning program 900 uses the features 906 for analyzing query data 912 to generate outcomes or predictions, as examples of an assessment 916.

In the training phase 902, feature engineering is used to identify features 906 and may include identifying informative, discriminating, and independent features for the effective operation of the machine learning program 900 in pattern recognition, classification, and regression. In some examples, the training data 908 includes labeled data, which is known data for pre-identified features 906 and one or more outcomes. Each of the features 906 may be a variable or attribute, such as individual measurable property of a process, article, system, or phenomenon represented by a data set (e.g., the training data 908). Features 906 may also be of different types, such as numeric features, strings, and graphs, and may include one or more of content 918, concepts 920, attributes 922, historical data 924 and/or user data 926, merely for example.

The concept of a feature in this context is related to that of an explanatory variable used in statistical techniques such as linear regression. Choosing informative, discriminating, and independent features is important for the effective operation of the machine learning program 900 in pattern recognition, classification, and regression. Features may be of different types, such as numeric features, strings, and graphs.

In training phases 902, the machine learning program 900 uses the training data 908 to find correlations among the features 906 that affect a predicted outcome or assessment 916.

With the training data 908 and the identified features 906, the machine learning program 900 is trained during the training phase 902 at machine learning program training 910. The machine learning program 900 appraises values of the features 906 as they correlate to the training data 908. The result of the training is the trained machine learning program 914 (e.g., a trained or learned model).

Further, the training phases 902 may involve machine learning, in which the training data 908 is structured (e.g., labeled during preprocessing operations), and the trained machine learning program 914 implements a relatively simple neural network 928 capable of performing, for example, classification and clustering operations. In other examples, the training phase 902 may involve deep learning, in which the training data 908 is unstructured, and the trained machine learning program 914 implements a deep neural network 928 that is able to perform both feature extraction and classification/clustering operations.

A neural network 928 generated during the training phase 902, and implemented within the trained machine learning program 914, may include a hierarchical (e.g., layered) organization of neurons. For example, neurons (or nodes) may be arranged hierarchically into a number of layers, including an input layer, an output layer, and multiple hidden layers. Each of the layers within the neural network 928 can have one or many neurons and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network 928 may also be one of a number of different types of neural networks, including a single-layer feed-forward network, an Artificial Neural Network (ANN), a Recurrent Neural Network (RNN), a symmetrically connected neural network, and unsupervised pre-trained network, a transformer network, a Convolutional Neural Network (CNN), or a Recursive Neural Network (RNN), merely for example.

During prediction phases 904, the trained machine learning program 914 is used to perform an assessment. Query data 912 is provided as an input to the trained machine learning program 914, and the trained machine learning program 914 generates the assessment 916 as output, responsive to receipt of the query data 912.

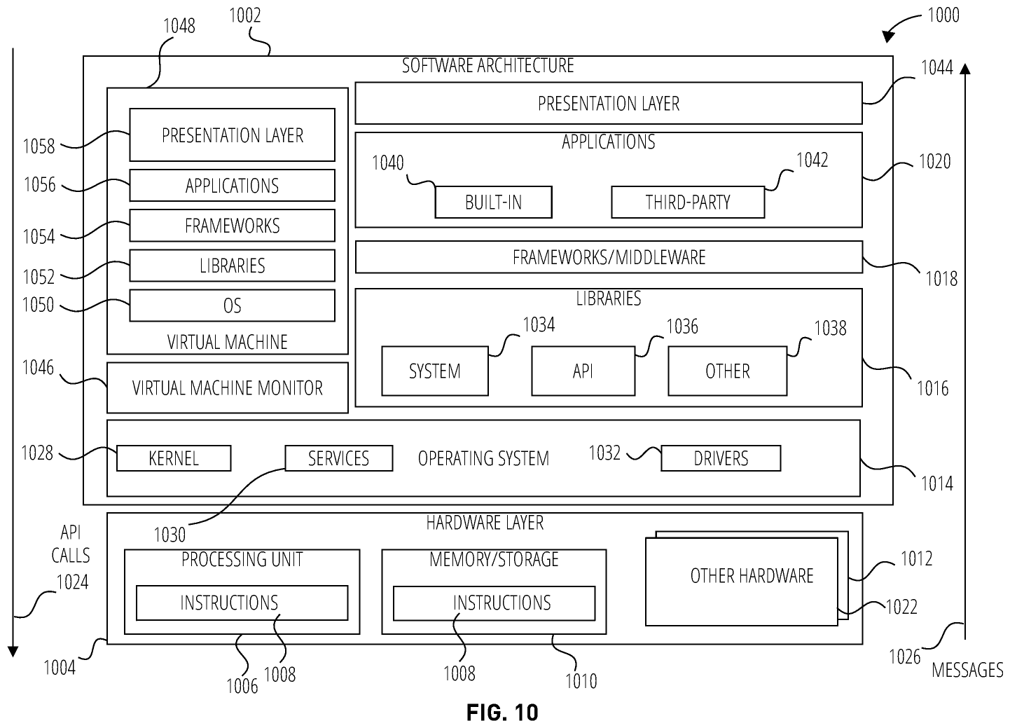

FIG. 10 is a block diagram 1000 showing a software architecture 1002 for a computing device, according to some examples. The software architecture 1002 may be used in conjunction with various hardware architectures, for example, as described herein. FIG. 10 is merely a non-limiting illustration of a software architecture, and many other architectures may be implemented to facilitate the functionality described herein. A representative hardware layer 1004 is illustrated and can represent, for example, any of the above referenced computing devices. In some examples, the hardware layer 1004 may be implemented according to the architecture of the computer system of FIG. 11.

The representative hardware layer 1004 comprises one or more processing units 1006 having associated executable instructions 1008. Executable instructions 1008 represent the executable instructions of the software architecture 1002, including implementation of the methods, modules, subsystems, and components, and so forth described herein and may also include memory and/or storage modules 1010, which also have executable instructions 1008. Hardware layer 1004 may also comprise other hardware as indicated by other hardware 1012 and other hardware 1022 which represent any other hardware of the hardware layer 1004, such as the other hardware illustrated as part of the software architecture 1002.

In the architecture of FIG. 10, the software architecture 1002 may be conceptualized as a stack of layers where each layer provides particular functionality. For example, the software architecture 1002 may include layers such as an operating system 1014, libraries 1016, frameworks/middleware layer 1018, applications 1020, and presentation layer 1044. Operationally, the applications 1020 or other components within the layers may invoke API calls 1024 through the software stack and access a response, returned values, and so forth illustrated as messages 1026 in response to the API calls 1024. The layers illustrated are representative in nature and not all software architectures have all layers. For example, some mobile or special purpose operating systems may not provide a frameworks/middleware layer 1018, while others may provide such a layer. Other software architectures may include additional or different layers.

The operating system 1014 may manage hardware resources and provide common services. The operating system 1014 may include, for example, a kernel 1028, services 1030, and drivers 1032. The kernel 1028 may act as an abstraction layer between the hardware and the other software layers. For example, the kernel 1028 may be responsible for memory management, processor management (e.g., scheduling), component management, networking, security settings, and so on. The services 1030 may provide other common services for the other software layers. In some examples, the services 1030 include an interrupt service. The interrupt service may detect the receipt of an interrupt and, in response, cause the software architecture 1002 to pause its current processing and execute an interrupt service routine (ISR) when an interrupt is accessed.

The drivers 1032 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 1016 may provide a common infrastructure that may be utilized by the applications 1020 or other components or layers. The libraries 1016 typically provide functionality that allows other software modules to perform tasks in an easier fashion than to interface directly with the underlying operating system 1014 functionality (e.g., kernel 1028, services 1030 or drivers 1032). The libraries 1016 may include system libraries 1034 (e.g., C standard library) that may provide functions such as memory allocation functions, string manipulation functions, mathematic functions, and the like. In addition, the libraries 1016 may include API libraries 1036 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 1016 may also include a wide variety of other libraries 1038 to provide many other APIs to the applications 1020 and other software components/modules.

The frameworks/middleware layer 1018 may provide a higher-level common infrastructure that may be utilized by the applications 1020 or other software components/modules. For example, the frameworks/middleware layer 1018 may provide various graphic user interface (GUI) functions, high-level resource management, high-level location services, and so forth. The frameworks/middleware layer 1018 may provide a broad spectrum of other APIs that may be utilized by the applications 1020 or other software components/modules, some of which may be specific to a particular operating system or platform.

The applications 1020 include built-in applications 1040 or third-party applications 1042. Examples of representative built-in applications 1040 may include, but are not limited to, a contacts application, a browser application, a book reader application, a location application, a media application, a messaging application, or a game application. Third-party applications 1042 may include any of the built-in applications as well as a broad assortment of other applications. In a specific example, the third-party application 1042 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 1042 may invoke the API calls 1024 provided by the mobile operating system such as operating system 1014 to facilitate functionality described herein.

The applications 1020 may utilize built in operating system functions (e.g., kernel 1028, services 1030 or drivers 1032), libraries (e.g., system libraries 1034, API libraries 1036, and other libraries 1038), and frameworks/middleware layer 1018 to create user interfaces to interact with users of the system. Alternatively, or additionally, in some systems, interactions with a user may occur through a presentation layer, such as presentation layer 1044. In these systems, the application/module “logic” can be separated from the aspects of the application/module that interact with a user.

Some software architectures utilize virtual machines. In the example of FIG. 10, this is illustrated by virtual machine 1048. A virtual machine creates a software environment where applications/modules can execute as if they were executing on a hardware computing device. A virtual machine is hosted by a host operating system (operating system 1014) and typically, although not always, has a virtual machine monitor 1046, which manages the operation of the virtual machine as well as the interface with the host operating system (e.g., operating system 1014). A software architecture executes within the virtual machine 1048 such as an operating system 1050, libraries 1052, frameworks/middleware 1054, applications 1056 or presentation layer 1058. These layers of software architecture executing within the virtual machine 1048 can be the same as corresponding layers previously described or may be different.

Certain examples are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In examples, one or more computer systems (e.g., a standalone, client, or server computer system) or one or more hardware processors may be configured by software (e.g., an application or application portion) as a hardware-implemented module that operates to perform certain operations as described herein.

In various examples, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner or to perform certain operations described herein. Considering examples in which hardware-implemented modules are temporarily configured (e.g., programmed), each of the hardware-implemented modules need not be configured or instantiated at any one instance in time. For example, where the hardware-implemented modules comprise, a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In examples in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some examples, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some examples, the processor or processors may be located in a single location (e.g., within a home environment, an office environment, or a server farm), while in other examples the processors may be distributed across a number of locations.

The one or more processors may also operate to support performance of the relevant operations in a “cloud computing” environment or as a “software as a service (SaaS).” For example, at least some of the operations may be performed by a group of computers (as examples of machines including processors), these operations being accessible via a network (e.g., the Internet) and via one or more appropriate interfaces (e.g., APIs).

Examples may be implemented in digital electronic circuitry, or in computer hardware, firmware, or software, or in combinations of them. Examples may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In examples, operations may be performed by one or more programmable processors executing a computer program to perform functions by operating on input data and generating output. Method operations can also be performed by, and apparatus of some examples may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In examples deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various examples.

FIG. 11 is a block diagram of a machine in the example form of a computer system 1100 within which instructions 1124 may be executed for causing the machine to perform any one or more of the methodologies discussed herein. In alternative examples, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a GPU, or both), a primary or main memory 1104, and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard or a touch-sensitive display screen), a UI navigation (or cursor control) device 1114 (e.g., a mouse), a storage unit 1116, a signal generation device 1118 (e.g., a speaker), and a network interface device 1120.

The storage unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 or within the processor 1102 during execution thereof by the computer system 1100, with the main memory 1104 and the processor 1102 also each constituting a machine-readable medium 1122.

While the machine-readable medium 1122 is shown in accordance with some examples to be a single medium, the term “machine-readable medium” may include a single medium or multiple media (e.g., a centralized or distributed database, or associated caches and servers) that store the one or more instructions 1124 or data structures. The term “machine-readable medium” shall also be taken to include any tangible medium that is capable of storing, encoding, or carrying instructions 1124 for execution by the machine and that cause the machine to perform any one or more of the methodologies of the present disclosure, or that is capable of storing, encoding, or carrying data structures utilized by or associated with such instructions 1124. The term “machine-readable medium” shall accordingly be taken to include, but not be limited to, solid-state memories, and optical and magnetic media. Specific examples of a machine-readable medium 1122 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

The instructions 1124 may further be transmitted or received over a communications network 1126 using a transmission medium. The instructions 1124 may be transmitted using the network interface device 1120 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., Wi-Fi and Wi-Max networks). The term “transmission medium” shall be taken to include any intangible medium that is capable of storing, encoding, or carrying instructions 1124 for execution by the machine, and includes digital or analog communications signals or other intangible media to facilitate communication of such software.

Although specific examples are described herein, it will be evident that various modifications and changes may be made to these examples without departing from the broader spirit and scope of the disclosure. Accordingly, the specification and drawings are to be regarded in an illustrative rather than a restrictive sense. The accompanying drawings that form a part hereof show by way of illustration, and not of limitation, specific examples in which the subject matter may be practiced. The examples illustrated are described in sufficient detail to enable those skilled in the art to practice the teachings disclosed herein. Other examples may be utilized and derived therefrom, such that structural and logical substitutions and changes may be made without departing from the scope of this disclosure. This detailed description, therefore, is not to be taken in a limiting sense, and the scope of various examples is defined only by the appended claims, along with the full range of equivalents to which such claims are entitled.

Such examples of the inventive subject matter may be referred to herein, individually or collectively, by the “example” merely for convenience and without intending to voluntarily limit the scope of this application to any single example or concept if more than one is in fact disclosed. Thus, although specific examples have been illustrated and described herein, it should be appreciated that any arrangement calculated to achieve the same purpose may be substituted for the specific examples shown. This disclosure is intended to cover any and all adaptations or variations of various examples. Combinations of the above examples, and other examples not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number, respectively. The word “or” in reference to a list of two or more items, covers all of the following interpretations of the word: any one of the items in the list, all of the items in the list, and any combination of the items in the list.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

What is claimed is:

1. A system comprising:
at least one memory that stores instructions; and
one or more processors configured by the instructions to perform operations comprising:
accessing a data record of a reported issue associated with a software offering provided to a user, the data record comprising issue metadata that includes a first priority rating for the reported issue;
using the issue metadata to identify a relation between the reported issue and context data associated with the user;
generating, based on at least the context data, a second priority rating for the reported issue, the second priority rating differing from the first priority rating; and
causing presentation of the second priority rating at a computing device.

2. The system of claim 1, wherein the generating of the second priority rating comprises determining, based on the context data and the data record, an estimated impact associated with the reported issue.

3. The system of claim 2, wherein the estimated impact is an estimated business impact.

4. The system of claim 2, wherein the determining of the estimated impact associated with the reported issue comprises detecting a dependency between the reported issue and at least one context attribute in the context data.

5. The system of claim 1, the operations further comprising:
augmenting the issue metadata with the context data to obtain augmented issue metadata, wherein the second priority rating is generated based on the augmented issue metadata.

6. The system of claim 1, wherein the using of the issue metadata to identify the relation between the reported issue and the context data comprises:
determining that data forming part of the issue metadata matches data in one or more context data sources associated with the user; and
retrieving the context data from the one or more context data sources.

7. The system of claim 6, wherein the one or more context data sources comprise at least one of: a data repository storing user data; a data repository storing reported issues; or a runtime environment associated with the user.

8. The system of claim 1, wherein the reported issue is one of a plurality of reported issues in an issue queue, and the second priority rating is indicative of an urgency of the reported issue relative to other reported issues in the plurality of reported issues.

9. The system of claim 8, the operations further comprising:
adjusting a position of the reported issue within the issue queue based on the second priority rating; and
causing presentation of the issue queue at the computing device, the issue queue reflecting the adjusted position of the reported issue.

10. The system of claim 1, wherein the issue metadata further comprises at least one of: a user identifier; a reported issue identifier; a reported issue description; a software offering identifier; a software offering instance identifier; or an escalation status.

11. The system of claim 1, wherein the reported issue is a first reported issue, the software offering is a first software offering, and the context data comprises one or more context attributes, the context attributes including at least one of: the first priority rating of the first reported issue; an escalation status of the first reported issue; a further reported issue associated with the user; a further software offering provided to the user; user contractual data; business opportunity data; availability of the first software offering; usage of the first software offering; availability of the further software offering; usage of the further software offering; runtime environment data of the first software offering; or runtime environment data of the further software offering.

12. The system of claim 1, wherein the context data comprises a plurality of context attributes, and the generating of the second priority rating comprises:
generating an impact score for each context attribute;
aggregating the impact scores to obtain an aggregated impact score; and
determining the second priority rating based on the aggregated impact score.

13. The system of claim 1, wherein the second priority rating is generated by using at least one of: a processor-implemented rules engine; or a machine learning model that is trained to generate, based on a given reported issue and given context data, a second priority rating for the given reported issue.

14. The system of claim 1, wherein the causing presentation of the second priority rating at the computing device comprises causing presentation, via a graphical user interface of the computing device that provides an issue dashboard, of the second priority rating together with the first priority rating.

15. A method comprising:
accessing a data record of a reported issue associated with a software offering provided to a user, the data record comprising issue metadata that includes a first priority rating for the reported issue;
using the issue metadata to identify a relation between the reported issue and context data associated with the user;
generating, based on at least the context data, a second priority rating for the reported issue, the second priority rating differing from the first priority rating; and
causing presentation of the second priority rating at a computing device.

16. The method of claim 15, wherein the generating of the second priority rating comprises determining, based on the data record and the context data, an estimated impact associated with the reported issue.

17. The method of claim 15, further comprising:
augmenting the issue metadata with the context data to obtain augmented issue metadata, wherein the second priority rating is generated based on the augmented issue metadata.

18. A non-transitory computer-readable medium that stores instructions that, when executed by one or more processors, cause the one or more processors to perform operations comprising:
accessing a data record of a reported issue associated with a software offering provided to a user, the data record comprising issue metadata that includes a first priority rating for the reported issue;
using the issue metadata to identify a relation between the reported issue and context data associated with the user;
generating, based on at least the context data, a second priority rating for the reported issue, the second priority rating differing from the first priority rating; and
causing presentation of the second priority rating at a computing device.

19. The non-transitory computer-readable medium of claim 18, wherein the generating of the second priority rating comprises determining, based on the data record and the context data, an estimated impact associated with the reported issue.

20. The non-transitory computer-readable medium of claim 18, the operations further comprising:
augmenting the issue metadata with the context data to obtain augmented issue metadata, wherein the second priority rating is generated based on the augmented issue metadata.
